(19) United States
(12) Patent Application Publication
(10) Pub. No.: US 2026/0279697 A1
(43) Pub. Date: Sep. 17, 2026

(54) BATTERY PACK AND PACK CASE, AND VEHICLE INCLUDING THE SAME

(71) Applicant: LG ENERGY SOLUTION, LTD., Seoul (KR)

(72) Inventors: Sung-Tack HWANG, Daejeon (KR); Tae-Hee KIM, Daejeon (KR); Young-Jun LEE, Daejeon (KR)

(73) Assignee: LG ENERGY SOLUTION, LTD., Seoul (KR)

(21) Appl. No.: 19/545,673

(22) Filed: Feb. 20, 2026

(30) Foreign Application Priority Data
Mar. 13, 2025 (KR) 10-2025-0032752
Nov. 26, 2025 (KR) 10-2025-0182343

(51) Int. Cl. H01H 9/22; B60R 16/033; H01H 1/58; H01M 50/249; H01M 50/271; H01M 50/574

(52) U.S. Cl. CPC H01H 9/22; B60R 16/033; H01H 1/5833; H01M 50/249; H01M 50/271; H01M 50/574; H01H 2001/5877

(57) ABSTRACT

A battery pack according to an embodiment of the disclosure includes: a plurality of battery cells; a pack case that accommodate the plurality of battery cells; and a power disconnector provided inside the pack case.

### CROSS-REFERENCE TO RELATED APPLICATIONS

This application is based on and claims priority from Korean Patent Application No. 10-2025-0032752 filed on Mar. 13, 2025, and Korean Patent Application No. 10-2025-0182343 filed on Nov. 26, 2025, with the Korean Intellectual Property Office, the disclosures of which are incorporated herein in their entirety by reference.

### TECHNICAL FIELD

The present disclosure relates to a battery pack and a pack case, and a vehicle including the same.

### BACKGROUND

Secondary batteries having high applicability depending on product groups and electrical characteristics such as high energy density are generally applied not only to the portable devices but also to, for example, electric vehicles (EVs) and hybrid electric vehicles (HEVs) driven by electric power sources.

These secondary batteries not only have the primary advantage of being able to dramatically reduce the use of fossil fuels, but also have the advantage of not generating any by-products due to energy use. Therefore, the secondary batteries are attracting attention as a new energy source to improve eco-friendliness and energy efficiency.

The types of secondary batteries currently used widely include, for example, lithium-ion batteries, lithium polymer batteries, nickel-cadmium batteries, nickel-metal hydride batteries, and nickel-zinc batteries. The operating voltage of such unit secondary battery cells ranges from about 2.5 V to about 4.5 V.

Accordingly, when a higher output voltage is required higher than the output voltage of the unit cell, a battery module or a battery pack is configured by connecting a plurality of battery cells in series. In addition, depending on a required charge and discharge capacity, a battery module or a battery pack may be configured by connecting a plurality of battery cells in parallel. Therefore, the number of battery cells included in the battery module or the battery pack and an electrical connection configuration thereof may be variously set according to at least one of the required output voltage and the required charge and discharge capacity.

### SUMMARY

The present disclosure provides a battery pack including a power disconnection member capable of disconnecting an electrical connection of a high-voltage portion during assembly, maintenance, or repair of the battery pack, and a vehicle including the battery pack.

The present disclosure provides a battery pack in which the power disconnection member is provided inside a pack case of the battery pack so that the size of the power disconnection member is reduced, thereby improving the space utilization of the power disconnection member in design and allowing the power disconnection member to be provided at various positions. The present disclosure also provides a vehicle including the battery pack.

The present disclosure provides a battery pack in which the size of the power disconnection member is reduced, thereby being advantageous in terms of manufacturing cost, and a vehicle including the battery pack.

The present disclosure provides a battery pack capable of ensuring operator safety by disconnecting an electrical connection of a high-voltage portion by means of the power disconnection member, and a vehicle including the battery pack.

However, the technical features of the present disclosure are not limited to the above-described problems, and other features not mentioned above will be clearly understood by those ordinarily skilled in the art from the description of the present disclosure set forth below.

According to an aspect of the present disclosure, a battery pack includes a plurality of battery cells, a pack case that accommodates the plurality of battery cells, and a power disconnection member provided inside the pack case.

In an embodiment, the pack case may include a seating portion and a cover covering the seating portion, and the power disconnection member may be provided in the seating portion and protected by the cover.

In an embodiment, an interlock connector may be formed in the cover, and the interlock connector may be coupled to the power disconnection member provided in the seating portion.

In an embodiment, the power disconnection member may include a mounting member mounted inside the pack case, a busbar coupled to the mounting member, and a cover member coupled to the mounting member so as to cover at least a portion of the busbar.

In an embodiment, the mounting member may have a through-hole through which the cover member is movable.

In an embodiment, the cover member may include a body portion coupled to the mounting member, and a guide portion extending from the body portion and positioned in the through-hole formed in the mounting member.

In an embodiment, the body portion of the cover member may be configured to be movable along the through-hole while being guided by the guide portion.

In an embodiment, the mounting member may have formed thereon a hook portion that is elastically deformable.

In an embodiment, the guide portion of the cover member may include a rod portion extending from the body portion of the cover member, and a hook coupling portion extending from the rod portion and configured to be coupled to the hook portion when the body portion of the cover member moves toward the hook portion side of the mounting member.

In an embodiment, the mounting member may be provided with a pair of hook portions that are coupled to the hook coupling portion of the cover member.

In an embodiment, the hook coupling portion of the cover member may include a first portion formed in a length direction, a second portion spaced apart from the first portion by a predetermined distance, a third portion spaced apart from the second portion by a predetermined distance, and a fourth portion configured to connect the first portion, the second portion, and the third portion.

In an embodiment, a first coupling groove may be formed between the first portion and the second portion to couple with one of the pair of hook portions in the mounting member, and a second coupling groove may be formed between the second portion and the third portion to couple with the other one of the pair of hook portions.

In an embodiment, the mounting member has an insertion hole having a shape corresponding to the hook coupling portion such that the hook coupling portion of the cover member is insertable therein.

In an embodiment, the power disconnection member may include a mounting member mounted inside the pack case, and a connector coupling portion may be formed on the mounting member to be coupled to the interlock connector formed in the cover.

According to another aspect of the present disclosure, a pack case that accommodates a battery pack including a plurality of battery cells, in which a power disconnection member is provided inside the pack case, the pack case includes a cover configured to cover the power disconnection member, and the power disconnection member is protected by the cover.

An interlock connector may be formed on the cover, and the interlock connector may be coupled to the power disconnection member provided inside the pack case.

The power disconnection member may include a mounting member mounted inside the pack case, a busbar coupled to the mounting member, and a cover member coupled to the mounting member so as to cover at least a portion of the busbar, and the cover member may be coupled to the interlock connector of the cover.

When the cover is opened, the interlock connector of the cover and the cover member may be separated from each other so that an electrical connection of the battery pack is disconnected.

Meanwhile, according to another aspect of the present disclosure, there may be provided a vehicle including at least one of the battery pack or the pack case described above.

According to the embodiments of the present disclosure, an electrical connection of a high-voltage portion may be disconnected during assembly, maintenance, or repair of a battery pack.

According to the embodiments of the present disclosure, since the power disconnection member is provided inside the pack case of the battery pack, the size of the power disconnection member may be reduced. Accordingly, the space utilization of the power disconnection member may be enhanced during design and the power disconnection member may be provided at various positions.

According to the embodiments of the present disclosure, since the size of the power disconnection member is reduced, advantageous effects may be provided in terms of manufacturing cost.

According to the embodiments of the present disclosure, an operator safety may be ensured by disconnecting an electrical connection of a high-voltage portion of the battery pack by the power disconnection member.

However, the effects obtainable through the present disclosure are not limited to the effects described above, and other technical effects not mentioned herein will be clearly understood by those ordinarily skilled in the art from the description of the present disclosure set forth below.

### BRIEF DESCRIPTION OF THE DRAWINGS

The following drawings attached hereto illustrate embodiments of the present disclosure and serve to further understand the technical idea of the present disclosure together with the content of the disclosure described above. Therefore, the present disclosure should not be construed as being limited to the matters illustrated in the drawings.

FIG. 1 is a schematic perspective view of a battery pack according to an embodiment of the disclosure.

FIG. 2 is a perspective view illustrating the battery pack of FIG. 1 in a state where a bottom surface of the battery pack is positioned upward.

FIG. 3 is a perspective view of a cover in which an interlock connector is formed in the battery pack according to an embodiment of the disclosure.

FIG. 4 is a perspective view illustrating a power disconnection member provided in the battery pack according to an embodiment of the disclosure, in an assembled state.

FIG. 5 is a perspective view illustrating the power disconnection member provided in the battery pack according to an embodiment of the disclosure, in a disassembled state.

FIG. 6 is a top plan view illustrating a mounting member in the power disconnection member provided in the battery pack according to an embodiment of the disclosure.

FIG. 7 is a bottom view illustrating the mounting member in the power disconnection member provided in the battery pack according to an embodiment of the disclosure.

FIG. 8 is a perspective view illustrating a lower portion of the cover member in the power disconnection member provided in the battery pack according to an embodiment of the disclosure.

FIG. 9 is an enlarged view of portion A of FIG. 8.

FIG. 10 is a bottom view illustrating a state where the cover member is coupled to the mounting member in the power disconnection member provided in the battery pack according to an embodiment of the disclosure.

FIGS. 11-13 are views illustrating a process in which the cover member moves in the power disconnection member provided in a battery pack according to an embodiment of the disclosure.

FIGS. 14-16 are views illustrating a process in which a hook coupling portion of the cover member is coupled to the hook portion formed in the mounting member by movement of the cover member in the power disconnection member provided in the battery pack according to an embodiment of the disclosure.

FIG. 17 is a view illustrating a vehicle including a battery pack according to various embodiments of the disclosure.

Corresponding reference characters indicate corresponding components throughout the several views of the drawings. The drawing figures presented are illustrated for simplicity and clarity and have not necessarily been drawn to scale. For example, the dimensions of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments.

### DETAILED DESCRIPTION

Hereinafter, embodiments of the present disclosure will be described in detail with reference to the accompanying drawings. The terms or words used in the specification and claims should not be construed as being limited to their ordinary or dictionary meanings, but should be construed as having meanings and concepts consistent with the technical spirit of the present disclosure based on the principle that an inventor may appropriately define the concepts of terms in order to explain the inventor’s own invention in the best manner. Accordingly, the embodiments described in the present specification and the configurations illustrated in the drawings are merely example embodiments of the present disclosure and do not represent all of the technical spirit of the present disclosure. Therefore, it should be understood that various equivalents and modifications capable of replacing these embodiments may exist at the time of filing of the present application.

In the drawings, the sizes of respective components or specific portions constituting the components may be exaggerated, omitted, or schematically illustrated for convenience and clarity of description. Accordingly, the sizes of the respective components do not completely reflect the actual sizes thereof. In the following description, detailed descriptions of known functions and configurations incorporated herein will be omitted when it may make the subject matter of the present disclosure rather unclear.

As used herein, the terms "coupling" or "connection" include not only cases where one member is directly coupled to or directly connected to another member, but also cases where one member is indirectly coupled to or indirectly connected to another member through an intermediate member.

The content described in one embodiment of the present disclosure that is common to another embodiment may be applied to the other embodiment. For example, in a second embodiment, content common to content described in a first embodiment may be replaced with the description of the first embodiment set forth above, and such a common content may also be applied to the second embodiment. In addition, among the content described in the second embodiment, content applicable to the first embodiment may be applied to the first embodiment. The same applies to other embodiments.

In general, high-voltage components and low-voltage components are used in a battery pack, and for operator safety, an electrical connection of a high-voltage portion of the components should be disconnected during assembly, maintenance, or repair of the battery pack.

Conventionally, in order to disconnect an electrical connection of a high-voltage portion, for example, a manual service device (MSD) has been used.

However, since the conventional high-voltage disconnection device is provided outside a pack case of a battery pack, waterproof performance of at least a predetermined level is required to be satisfied, and the rigidity of at least a predetermined level is also required to withstand the external pressure.

Further, when the high-voltage disconnection device is designed to satisfy such waterproof performance and rigidity requirements, the size of the high-voltage disconnection device increases. Accordingly, there is a problem in that there are significant constraints in terms of available space in a vehicle and space of the battery pack when designing the high-voltage disconnection device.

The disclosure has been made in consideration of the above-described points, and provides a power disconnection member that is provided inside the pack case of a battery pack to reduce a size thereof, thereby improving space utilization in design and enabling installation at various positions, and a battery pack case and a battery pack including the power disconnection member.

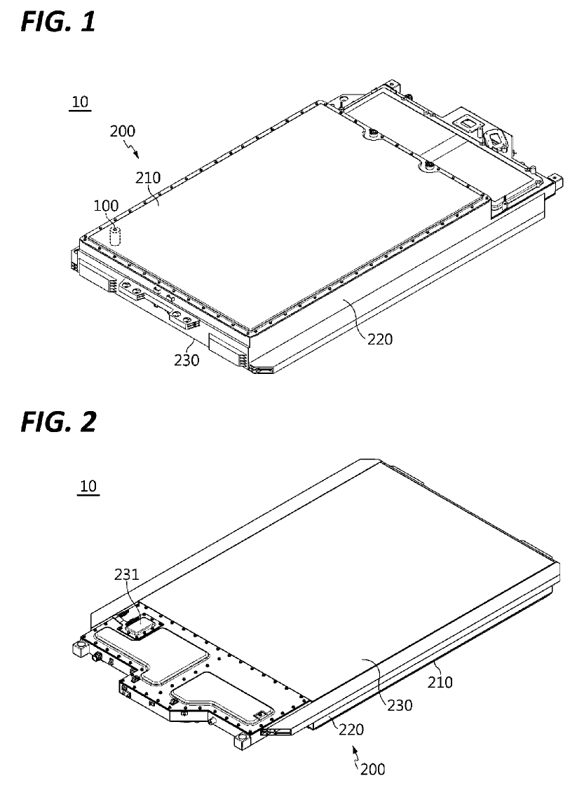

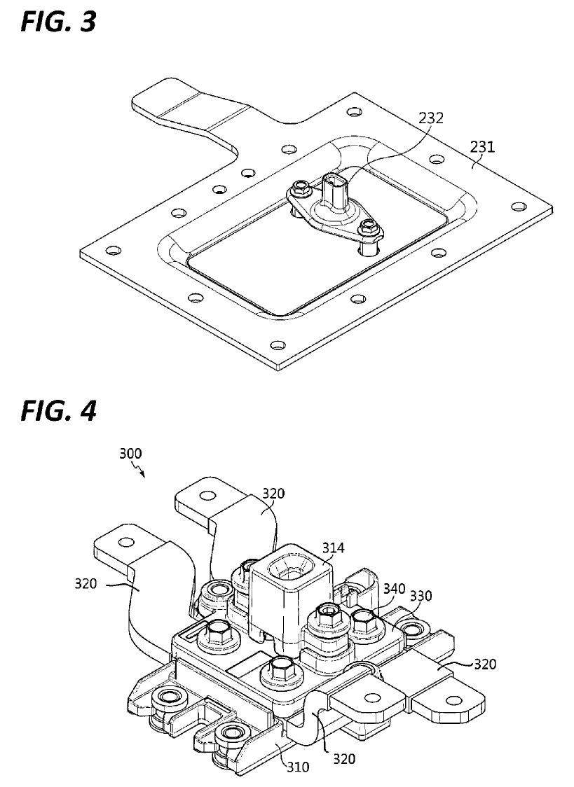

FIG. 1 is a schematic perspective view of a battery pack according to an embodiment of the disclosure, FIG. 2 is a perspective view illustrating the battery pack of FIG. 1 in a state where a bottom surface of the battery pack is positioned upward, and FIG. 3 is a perspective view of a cover in which an interlock connector is formed in the battery pack according to an embodiment of the disclosure.

Referring to FIGS. 1-3, the battery pack 10 according to an embodiment of the disclosure includes a plurality of battery cells 100, a pack case 200, and a power disconnection member 300 (see, e.g., FIG. 4).

The type of the battery cells 100 may vary. For example, the battery cells 100 may include at least one of pouch-type battery cells, cylindrical battery cells, and/or prismatic battery cells.

When the battery cells 100 are pouch-type battery cells, the plurality of battery cells 100 may be stacked on each other. The battery cells 100 may have various structures, and the plurality of battery cells 100 may also be stacked in various manners.

The battery cells 100 may have a structure in which a plurality of unit cells, each having electrode plates and a separator arranged in an order of a positive electrode plate–a separator–a negative electrode plate, or bi-cells, each having electrode plates and separators arranged in an order of a positive electrode plate–a separator–a negative electrode plate–a separator–a positive electrode plate–a separator–a negative electrode plate, are stacked in accordance with a battery capacity.

The battery cells 100 may be provided with electrode leads. Each electrode lead may be a type of terminal that is exposed to the outside and connected to an external device, and may be made of a conductive material. The electrode leads may include a positive electrode lead and a negative electrode lead.

The positive electrode lead and the negative electrode lead may be disposed in opposite directions with respect to a length direction of the battery cell 100, or the positive electrode lead and the negative electrode lead may be disposed in the same direction with respect to the length direction of the battery cell 100.

In an embodiment, pouch-type battery cells may be accommodated in a module case, and the module case accommodating the battery cells 100 may be accommodated in the pack case 200 to constitute the battery pack 10. For example, a battery module accommodating the battery cells 100 may be accommodated in the battery pack 10.

However, the present disclosure is not limited thereto, and the module case may be omitted to reduce the weight and volume of the module case. In this case, the battery cells 100 may be directly accommodated in the pack case 200 of the battery pack 10.

When the battery cells 100 are cylindrical battery cells, the battery cells 100 may each include an electrode assembly, a battery can, a cell terminal, a positive electrode current collector plate, a negative electrode current collector plate, an insulator, and a cap.

The cap is coupled to the battery can. Depending on a coupling method of the cap, the cylindrical battery cell may be classified into a type in which a crimping portion and a beading portion are not formed on the battery can, or a type in which a crimping portion and a beading portion are formed on the battery can.

When the beading portion and the crimping portion are not formed on the battery can, the cap may be directly welded to the battery can through various welding methods, for example, seam welding.

When the battery can and the cap of the battery cell 100 are welded by a seam welding method, the cap may be coupled to a side surface of the battery can by welding (e.g., horizontal welding). According to an embodiment, the cap may be coupled to be in contact with an inner side surface of an opening of the battery can. Alternatively, the cap may be coupled to an upper surface of the battery can by welding (e.g., vertical welding). In addition, the cap may be seated on an upper side of the opening of the battery can and welded thereto.

The plurality of battery cells 100 are accommodated in the pack case 200. The pack case 200 may include, for example, an upper frame 210, a side surface frame 220, and a lower frame 230. However, the present disclosure is not limited thereto.

The upper frame 210 may be coupled to the side surface frame 220. In a modified embodiment, the upper frame 210 may be integrally formed with the side surface frame 220, but the present disclosure is not limited thereto. The upper frame 210 may be formed in various shapes.

The side surface frame 220 may be configured to extend upward from an edge of the lower frame 230. The side surface frame 220 defines a height of the pack case 200 and forms a predetermined space with the lower frame 230.

The lower frame 230 is configured to allow a plurality of battery cells 100 to be seated thereon. The lower frame 230 may be formed in a rectangular plate shape, but is not limited thereto. The lower frame 230 forms a bottom portion of the pack case 200.

A seating portion may be formed in the pack case 200. The seating portion may be formed, for example, in the lower frame 230 of the pack case 200. According to an embodiment, the seating portion is formed inside a portion to which a cover 231 is coupled. Accordingly, in FIG. 2, the seating portion is covered by the cover 231. According to an embodiment of the disclosure, a power disconnection member 300 to be described later may be provided in the seating portion of the lower frame 230. When the cover 231 is separated from the lower frame 230, the seating portion is exposed to the outside, and the power disconnection member 300 to be described later may be provided in the seating portion formed in the pack case 200. In this manner, the power disconnection member 300 may be provided inside the pack case 200. In another embodiment, the power disconnection member 300 may be pre-installed in the seating portion, and the cover 231 may be designed to be coupled to a portion of the power disconnection member 300, such that the cover 231 protects the power disconnection member 300 provided inside the battery pack 10, and, when the cover 231 is separated from the lower frame 230, the power disconnection member 300 may be configured to disconnect power of the battery pack 10.

Referring to FIG. 2, after the power disconnection member 300 is installed in the seating portion of the lower frame 230, the cover 231 may be configured to cover the seating portion. Accordingly, the power disconnection member 300 is provided in the seating portion of the lower frame 230 and is protected by the cover 231.

Referring to FIG. 3, an interlock connector 232 is formed in the cover 231, which serves as a type of service port, and the interlock connector 232 may be coupled to the power disconnection member 300. For example, a coupling 314 (see, e.g., FIG. 4) formed on a mounting member 310 included in the power disconnection member 300 may be configured to be coupled to the interlock connector 232. The interlock connector 232 refers to a connector having a function of cutting off high voltage of the battery pack when the interlock connector 232 is not connected or is disconnected.

Referring to FIG. 2, as described above, the power disconnection member 300 is provided inside the pack case 200, for example, at the seating portion of the lower frame 230. The power disconnection member 300 is configured to disconnect an electrical connection of a high-voltage portion during assembly, maintenance, or repair of the battery pack 10.

As described above, since a conventional disconnection device is provided outside a frame of the battery pack 10, various problems arise.

However, since the power disconnection member 300 according to an embodiment of the disclosure is mounted inside the battery pack 10, the power disconnection member 300 may be protected by the frame of the battery pack 10. Accordingly, compared to a case where the power disconnection member 300 is provided outside the battery pack 10, waterproof performance requirements and rigidity requirements are less stringent, and thus, even when the size of the power disconnection member 300 is reduced, the waterproof performance requirements and the rigidity requirements may be sufficiently satisfied.

Accordingly, the size of the power disconnection member 300 may be reduced, and thus space utilization in designing the power disconnection member 300 is high. For example, since the power disconnection member 300 has a small size, the power disconnection member 300 may be provided even in a narrow space inside the battery pack 10. In addition, since the power disconnection member 300 has a small size, the installation position is not limited, and the power disconnection member 300 may be provided at various positions.

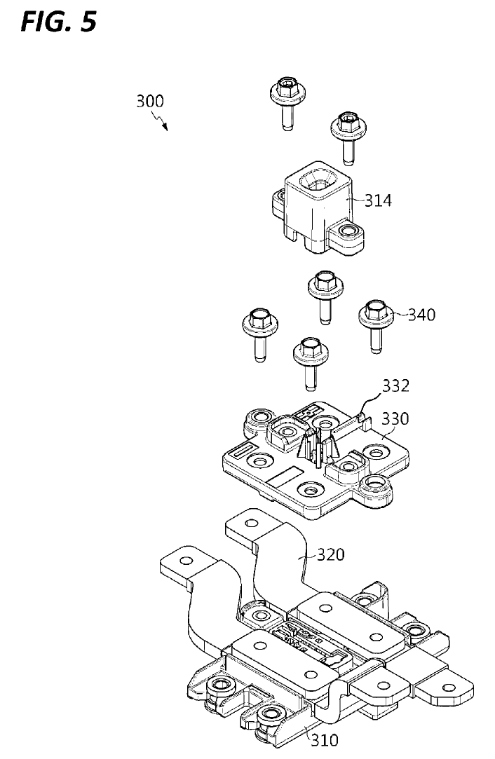

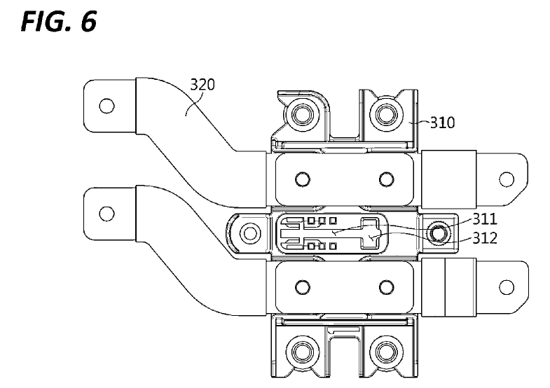

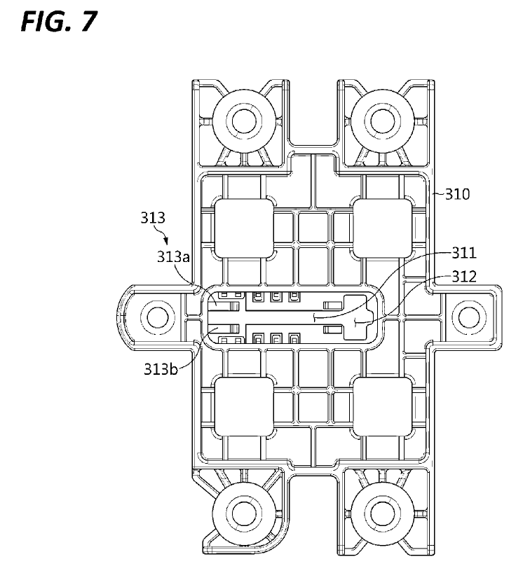

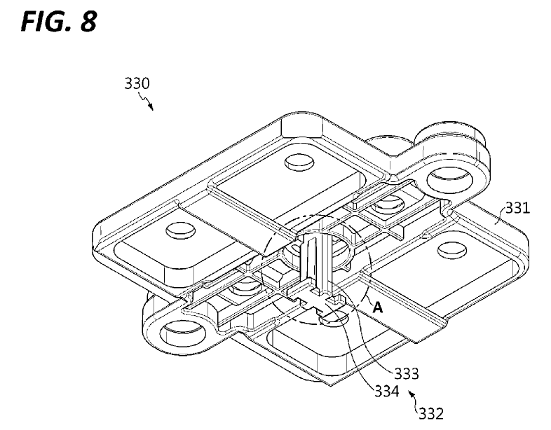

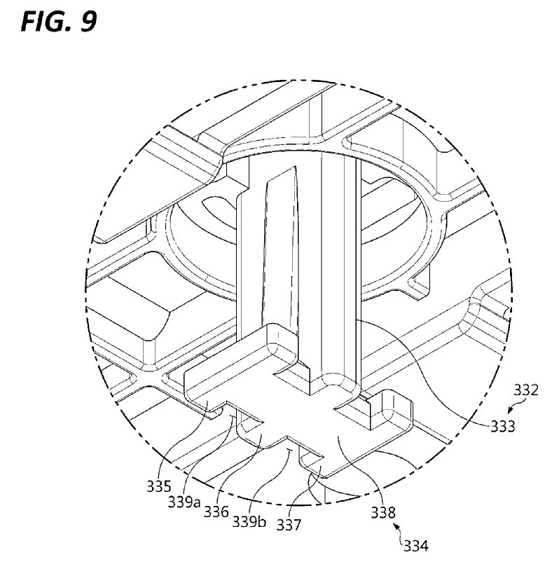

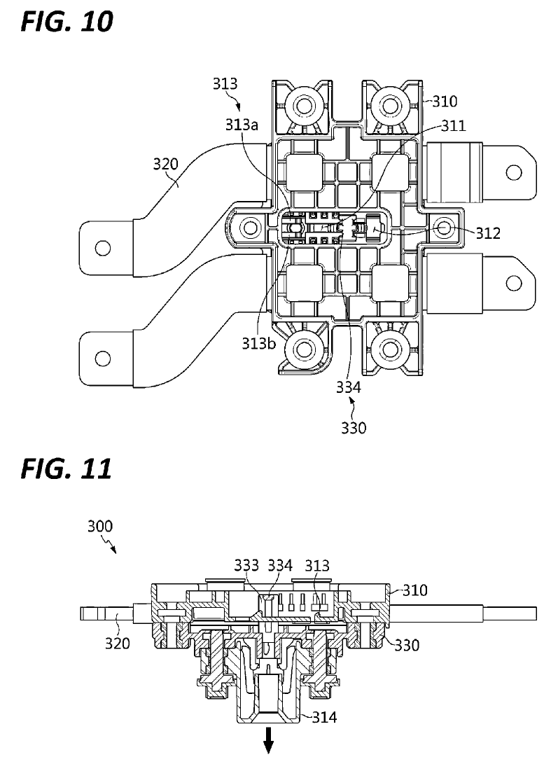

FIG. 4 is a perspective view illustrating the power disconnection member 300 provided in the battery pack 10 according to an embodiment of the disclosure, in an assembled state, and FIG. 5 is a perspective view illustrating the power disconnection member 300 provided in the battery pack 10 according to an embodiment of the disclosure, in a disassembled state. FIG. 6 is a top view illustrating the mounting member 310 in the power disconnection member 300 provided in the battery pack 10 according to an embodiment of the disclosure, and FIG. 7 is a bottom view illustrating the mounting member 310 in the power disconnection member 300 provided in the battery pack 10 according to an embodiment of the disclosure. FIG. 8 is a perspective view illustrating a lower portion of the cover member in the power disconnection member 300 provided in the battery pack 10 according to an embodiment of the disclosure, and FIG. 9 is an enlarged view of portion A of FIG. 8. FIG. 10 is a bottom view illustrating a state where the cover member 330 is coupled to the mounting member 310 in the power disconnection member 300 provided in the battery pack 10 according to an embodiment of the disclosure.

Referring to FIGS. 4 and 5, the power disconnection member 300 according to an embodiment of the disclosure may include a mounting member 310, a busbar 320, and a cover member 330.

The mounting member 310 is mounted inside the battery pack 10, for example, at a position corresponding to the cover 231. For example, referring to FIG. 2, the cover 231 is coupled to the bottom surface of the battery pack 10, and after the cover 231 is opened, the mounting member 310 may be mounted in a seating portion inside the battery pack 10. Then, the cover 231 may be coupled to protect the mounting member 310. However, the mounting member 310 may be mounted at various positions in the battery pack 10 without being limited to the above-described position.

Referring to FIG. 3, an interlock connector 232 may be formed on the cover 231. Referring to FIG. 4, a connector coupling portion 314 configured to be coupled to the interlock connector 232 formed on the cover 231 may be formed on the mounting member 310. With this configuration, for example, when the cover 231 is closed, the interlock connector 232 and the connector coupling portion 314 are coupled to each other, and when the cover 231 is opened, the interlock connector 232 and the connector coupling portion 314 are separated from each other.

Referring to FIGS. 6 and 7, a through-hole 311 may be formed in the mounting member 310. A guide portion 332 of the cover member 330 to be described later is configured to be positioned in the through-hole 311 and to move along the through-hole 311.

Referring to FIG. 7, an elastically deformable hook portion 313 may be formed in the mounting member 310. For example, a pair of hook portions 313 may be formed, and the pair of hook portions 313a and 313b may be positioned inside the through-hole 311. Referring to FIG. 7, the hook portion 313 is formed at one end of the through-hole 311 of the mounting member 310. However, the position of the hook portion 313 is not limited thereto.

An insertion hole 312 having a shape corresponding to a hook coupling portion 334 of the cover member 330 may be formed in the mounting member 310 so as to allow the hook coupling portion 334 of the cover member 330 to be inserted therethrough. The insertion hole 312 and the through-hole 311 communicate with each other, and the insertion hole 312 may be formed to have a greater width than the through-hole 311. Referring to FIG. 10, the hook coupling portion 334 and a rod portion 333 of the cover member 330 are inserted through the insertion hole 312 formed in the mounting member 310, and thereafter, the rod portion 333 coupled to the hook coupling portion 334 may move along the through-hole 311.

Referring to FIGS. 4 and 5, the busbar 320 is coupled to the mounting member 310. In FIG. 4, four busbars 320 are provided, and the busbars 320 have different lengths from each other. However, for example, the number, shape, coupling position, and connection direction of the busbars 320 may vary.

The busbars 320 have a function of allowing current to flow therethrough and may be formed of a conductive material, for example, copper or aluminum. However, the material of the busbars 320 is not limited thereto.

Referring to FIG. 4, the cover member 330 may be coupled to the mounting member 310 so as to partially cover the busbars 320. The cover member 330 may be coupled to the mounting member 310 in various manners. For example, the cover member 330 may be coupled to the mounting member 310 by fastening members 340 such as screws or bolts, but the coupling manner is not limited thereto.

In addition, the cover member 330 may be separated from the mounting member 310. When the cover member 330 is separated from the mounting member 310, an electrical connection of a high-voltage portion of the battery pack 10 is disconnected. Here, when the cover member 330 remains at a position at which the cover member 330 is separated from the mounting member 310, assembly, maintenance, or repair of the battery pack 10 may be hindered. Accordingly, the cover member 330 separated from the mounting member 310 may be configured to be movable in another direction.

Referring to FIGS. 8 and 9, the cover member 330 may include a body portion 331 and a guide portion 332. The body portion 331 is coupled to the mounting member 310. The body portion 331 may have various shapes, and for example, may be formed to have a shape corresponding to the mounting member 310.

The guide portion 332 of the cover member 330 extends from the body portion 331 and may be configured to be positioned in the through-hole 311 of the mounting member 310. The guide portion 332 guides the body portion 331 while moving along the through-hole 311 of the mounting member 310. In this manner, the cover member 330 may move along the through-hole 311 of the mounting member 310. For example, as described above, in order to disconnect a high-voltage connection by separating the cover member 330 from the mounting member 310, the cover member 330 may move along the through-hole 311 of the mounting member 310 so as not to interfere with various operations. For example, an operator may move the cover member 330 while gripping the body portion 331 of the cover member 330.

The body portion 331 of the cover member 330 may be configured to be movable along the through-hole 311 of the mounting member 310 while being guided by the guide portion 332, and specific movement of the body portion 331 will be described later.

Referring to FIG. 8, the guide portion 332 of the cover member 330 may include a rod portion 333 and a hook coupling portion 334. The rod portion 333 extends from the body portion 331 in a length direction. The hook coupling portion 334 extends from the rod portion 333 and is coupled to the hook portion 313 when the body portion 331 moves toward the hook portion 313 of the mounting member 310. In this manner, after the cover member 330 is separated from the mounting member 310, the cover member 330 moves in one direction, for example, toward a direction in which the hook portion 313 of the mounting member 310 is formed, so as to be fixedly coupled to the hook portion 313.

As described above, after the cover member 330 is separated from the mounting member 310, the cover member 330 moves along the through-hole 311 of the mounting member 310 so as not to interfere with various operations. However, even if the cover member 330 moves after being separated from the mounting member 310, when the cover member 330 is not fixed, the cover member 330 may still interfere with various operations.

Accordingly, in order to prevent or suppress such interference with operations, after the cover member 330 moves toward the hook portion 313 of the mounting member 310, the hook coupling portion 334 of the cover member 330 may be fixedly coupled to the hook portion 313 of the mounting member 310. As a result, after the cover member 330 is separated from the mounting member 310, interference with operations may be more effectively prevented or suppressed. Details regarding coupling of the hook coupling portion 334 of the cover member 330 to the hook portion 313 of the mounting member 310 will be described later.

Referring to FIG. 9, the hook coupling portion 334 of the cover member 330 may include a first portion 335, a second portion 336, a third portion 337, and a fourth portion 338.

The first portion 335 of the hook coupling portion 334 may be formed in a length direction. The first portion 335 may be formed, for example, in a linear shape, but is not limited thereto.

The second portion 336 of the hook coupling portion 334 may be disposed to be spaced apart from the first portion 335 by a predetermined distance. The second portion 336 may be formed parallel to the first portion 335. The second portion 336, like the first portion 335, may be formed, for example, in a linear shape, but is not limited thereto.

The third portion 337 of the hook coupling portion 334 may be disposed to be spaced apart from the second portion 336 by a predetermined distance. The third portion 337 may be formed parallel to the second portion 336. The third portion 337, like the second portion 336, may be formed, for example, in a linear shape, but is not limited thereto.

The first portion 335 and the third portion 337 of the hook coupling portion 334 may be positioned at opposite ends, and the second portion 336 may be positioned at a center between the first portion 335 and the third portion 337.

The fourth portion 338 of the hook coupling portion 334 is configured to connect the first portion 335, the second portion 336, and the third portion 337. The fourth portion 338 may be formed in a direction perpendicular to the first portion 335, but is not necessarily limited thereto. The fourth portion 338 may also be formed in a linear shape, but is not limited thereto.

As illustrated in FIG. 9, a first coupling groove 339a may be formed between the first portion 335 and the second portion 336 of the hook coupling portion 334. A second coupling groove 339b may be formed between the second portion 336 and the third portion 337.

One of the pair of hook portions 313a and 313b of the mounting member 310 may be coupled to the first coupling groove 339a between the first portion 335 and the second portion 336 of the hook coupling portion 334, and the other of the pair of hook portions 313a and 313b of the mounting member 310 may be coupled to the second coupling groove 339b between the second portion 336 and the third portion 337 of the hook coupling portion 334.

In this manner, when the pair of hook portions 313a and 313b of the mounting member 310 are respectively coupled to the first coupling groove 339a and the second coupling groove 339b of the hook coupling portion 334, the cover member 330 separated from the mounting member 310 may be fixed.

FIGS. 11-13 are views illustrating a process in which the cover member 330 moves in the power disconnection member 300 provided in a battery pack according to an embodiment of the disclosure.

With reference to FIGS. 11-13, descriptions will be made on a case where an electrical connection of a high-voltage portion is disconnected for assembly, maintenance, or repair of the battery pack 10.

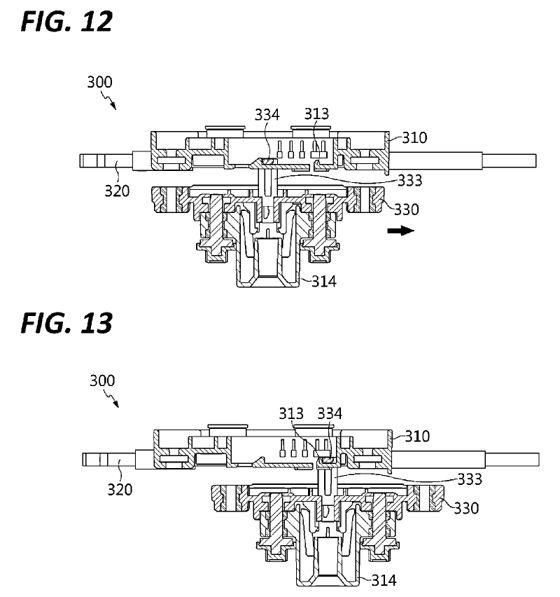

Referring to FIG. 11, the cover member 330 moves downward (e.g., see the arrow) with reference to FIG. 11, and as illustrated in FIG. 12, the cover member 330 is separated from the mounting member 310. Accordingly, the electrical connection of the battery pack 10 is disconnected. For example, while the cover 231 is in a closed state, the interlock connector 232 provided on the cover 231 and the connector coupling portion 314 remain coupled to each other. When the cover 231 is opened, the interlock connector 232 of the cover 231 and the connector coupling portion 314 are separated from each other, and the cover member 330 moves downward by gravity and is separated from the mounting member 310, thereby disconnecting the electrical connection of the battery pack 10.

However, when the cover member 330 remains at the position illustrated in FIG. 12, assembly, maintenance, or repair of the battery pack 10 by an operator may be hindered. Accordingly, the power disconnection member 300 according to an embodiment of the disclosure may prevent interference with an operator’s work by moving the cover member 330 in a predetermined direction.

The cover member 330 may move rightward with reference to FIG. 12 (e.g., in the arrow direction of FIG. 12). According to an embodiment, the body portion 331 of the cover member 330 moves rightward while being guided by the rod portion 333 of the guide portion 332 coupled to the body portion 331. Here, the rod portion 333 of the guide portion 332 moves along the through-hole 311 of the mounting member 310.

Referring to FIG. 13, the cover member 330 moves along the through-hole 311 of the mounting member 310 to the right end of the through-hole 311. In this manner, when the cover member 330 moves in a predetermined direction, an operator may perform work without interference from the power disconnection member 300.

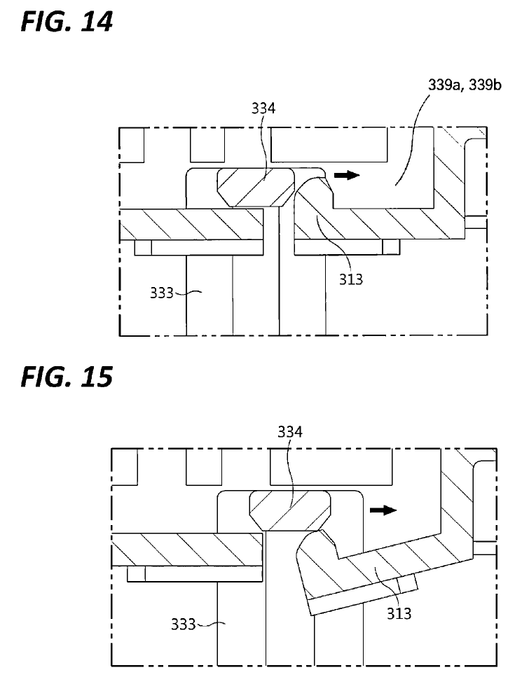

FIGS. 14-16 are views illustrating a process in which the hook coupling portion 334 of the cover member 330 is coupled to the hook portion 313 formed in the mounting member 310 by movement of the cover member 330 in the power disconnection member 300 provided in the battery pack according to an embodiment of the disclosure.

As described above with reference to FIGS. 11-13, even when the cover member 330 remains at its position after the movement, the cover member 330 may not interfere with an operator’s work. However, in some cases, fixing of the cover member 330 may be required.

Referring to FIG. 14, when the rod portion 333 of the cover member 330 moves rightward with reference to FIG. 14, as illustrated in FIG. 15, the hook portion 313 of the mounting member 310 is brought into contact with the hook coupling portion 334 of the cover member 330 and is elastically deformed downward.

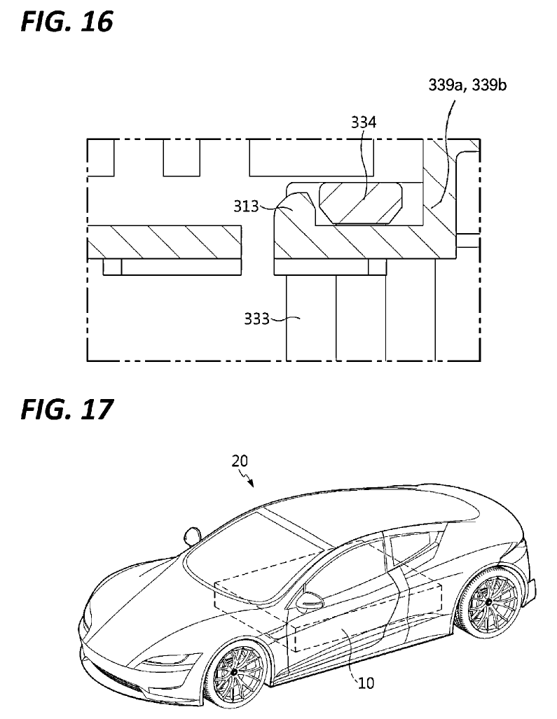

Further, as illustrated in FIG. 16, when the rod portion 333 of the cover member 330 reaches the rightmost end with reference to FIG. 16, the hook portion 313 of the mounting member 310 returns to its original position by elastic restoring force and is coupled to the first coupling groove 339a and the second coupling groove 339b formed in the hook coupling portion 334.

Here, when a pair of hook portion 313 are provided for the mounting member 310, one of the pair of hook portions 313a and 313b may be coupled to the first coupling groove 339a of the cover member 330, and the other of the pair of hook portions 313a and 313b may be coupled to the second coupling groove 339b of the cover member 330.

In this manner, when the hook portion 313 of the mounting member 310 is coupled to the hook coupling portion 334 of the cover member 330, the cover member 330 is completely fixed by the hook portion 313, thereby preventing interference with an operator’s work by the power disconnection member 300.

In embodiments of the disclosure, an electrical connection of a high-voltage portion may be disconnected during assembly, maintenance, or repair of the battery pack 10. In addition, in embodiments of the disclosure, since the power disconnection member 300 is provided inside the pack case 200 of the battery pack 10, the size of the power disconnection member 300 may be reduced. Accordingly, space utilization in design may be high, and the power disconnection member 300 may be provided at various positions. In addition, in embodiments of the disclosure, reducing the size of the power disconnection member 300 may be advantageous in terms of manufacturing cost. Further, in embodiments of the disclosure, operator safety may be ensured by disconnecting an electrical connection of a high-voltage portion by the power disconnection member 300.

FIG. 17 is a view illustrating a vehicle including a battery pack according to each embodiment of the disclosure.

Referring to FIG. 17, a vehicle 20 according to an embodiment of the disclosure may include one or more battery packs 10 according to the above-described embodiments. Here, the vehicle 20 may include, for example, various types of vehicles configured to use electricity, such as an electric vehicle or a hybrid electric vehicle.

In this specification, when terms indicating directions such as upper, lower, left, and right are used, such terms are merely for convenience of description, and it will be apparent to those ordinarily skilled in the art that the meanings of such terms may vary depending on a position of a target object or a position of an observer.

While the present disclosure has been described with reference to the limited embodiments and drawings, the present disclosure is not limited thereto, and various modifications and changes may be made by those skilled in the art of the present disclosure within the technical idea of the present disclosure and the scope equivalent to the claims set forth below. Therefore, the foregoing embodiments should be considered from the descriptive viewpoint, rather than from the limiting viewpoint. That is, the essential scope of the technical idea of the present disclosure may be found in the claims attached herewith, and any differences that fall under the equivalent scope to the present disclosure should be construed as being included in the present disclosure.

What is claimed is:

1. A battery pack comprising:
a plurality of battery cells;
a pack case configured to accommodate the plurality of battery cells; and
a power disconnector provided inside the pack case.

2. The battery pack according to claim 1, wherein the pack case includes a seating portion and a cover covering the seating portion, and
the power disconnector is provided in the seating portion and protected by the cover.

3. The battery pack according to claim 2, wherein an interlock connector is formed in the cover, and the interlock connector is coupled to the power disconnector provided in the seating portion.

4. The battery pack according to claim 1, wherein the power disconnector includes:
a mounting base mounted inside the pack case;
a busbar coupled to the mounting base; and
a disconnector cover coupled to the mounting base and configured to cover at least a portion of the busbar.

5. The battery pack according to claim 4, wherein the mounting base has a through-hole through which the disconnector cover is movable.

6. The battery pack according to claim 5, wherein the disconnector cover includes:
a body portion coupled to the mounting base, and
a guide portion extending from the body portion and positioned in the through-hole formed in the mounting base.

7. The battery pack according to claim 6, wherein the body portion of the disconnector cover is configured to be movable along the through-hole while being guided by the guide portion.

8. The battery pack according to claim 6, wherein the mounting base has formed thereon a hook portion that is elastically deformable.

9. The battery pack according to claim 8, wherein the guide portion of the disconnector cover includes:
a rod portion extending from the body portion of the disconnector cover, and
a hook coupling portion extending from the rod portion and configured to be coupled to the hook portion when the body portion of the disconnector cover moves toward the hook portion side of the mounting base.

10. The battery pack according to claim 9, wherein the mounting base is provided with a pair of hook portions that are coupled to the hook coupling portion of the disconnector cover.

11. The battery pack according to claim 10, wherein the hook coupling portion of the disconnector cover includes:
a first portion formed in a length direction;
a second portion spaced apart from the first portion by a predetermined distance;
a third portion spaced apart from the second portion by a predetermined distance; and
a fourth portion configured to connect the first portion, the second portion, and the third portion.

12. The battery pack according to claim 11, wherein a first coupling groove is formed between the first portion and the second portion and configured to couple with one of the pair of hook portions in the mounting base, and
a second coupling groove is formed between the second portion and the third portion and configured to couple with a remaining one of the pair of hook portions.

13. The battery pack according to claim 9, wherein the mounting base has an insertion hole having a shape corresponding to the hook coupling portion such that the hook coupling portion of the disconnector cover is insertable therein.

14. The battery pack according to claim 3, wherein the power disconnector includes a mounting base mounted inside the pack case, and
a connector coupling portion is formed on the mounting base and configured to be coupled to the interlock connector formed in the cover.

15. A vehicle comprising at least one of the battery pack according to claim 1.

16. A pack case that accommodates a battery pack including a plurality of battery cells, wherein
a power disconnector is provided inside the pack case,
the pack case includes a cover configured to cover the power disconnector, and
the power disconnector is protected by the cover.

17. The pack case according to claim 16, wherein an interlock connector is formed on the cover, and the interlock connector is coupled to the power disconnector provided inside the pack case.

18. The pack case according to claim 17, wherein the power disconnector includes:
a mounting base mounted inside the pack case;
a busbar coupled to the mounting base; and
a disconnector cover coupled to the mounting base and configured to cover at least a portion of the busbar, and
wherein the disconnector cover is coupled to the interlock connector of the cover.

19. The pack case according to claim 18, wherein when the cover is opened, the interlock connector of the cover and the disconnector cover are separated from each other so that an electrical connection of the battery pack is disconnected.
